(19) United States
(12) Patent Application Publication
(10) Pub. No.: US 2026/0270104 A1
(43) Pub. Date: Sep. 10, 2026

(54) Smart-Home Management Runtime

(71) Applicant: Google LLC, Mountain View, CA (US)

(72) Inventors: David Matthew Anthony Putzolu, Mountain View, CA (US); Micah Lemonik, Mountain View, CA (US)

(73) Assignee: Google LLC, Mountain View, CA (US)

(21) Appl. No.: 19/164,949

(22) PCT Filed: May 8, 2023
(86) PCT No.: PCT/US2023/066736

§ 371 Date: Sep. 12, 2025

Related U.S. Application Data
(60) Provisional application No. 63/493,522, filed on Mar. 31, 2023.

(51) Int. Cl. H04L 12/28

(52) U.S. Cl. CPC H04L 12/2827

(57) ABSTRACT

Techniques and devices for a smart-home management runtime by a hub in a home network are described in which the hub discovers if other hubs are present on the home network. If one or more other hubs are discovered, the hub connects with the one or more other hubs, partitions smart-home hub functions between the hub and the one or more other hubs, and based on the partitioning, provides at least some of the smart-home functions to devices on the home network. If no other hubs are present on the home network, the hub provides the smart-home functions to devices on the home network.

### BACKGROUND

Using wireless networking to connect devices to each other and to cloud-based services is increasingly popular for sensing environmental conditions, controlling equipment, and providing information and alerts to users for residential and commercial buildings. Many devices on wireless networks are designed to operate for extended periods of time on battery-power which limits the available computing, user interface, and radio resources in the devices.

This increasing popularity has led to multiple vendor-specific ecosystems of devices and networking protocols that may not interoperate. Smart-home devices have a variety of ways of being controlled, ranging from cloud-based control to proprietary local communication protocols over Wireless Local Area Networks (WLANs) (e.g., Wi-Fi) and Wireless Personal Area Networks (WPANs) (e.g., Bluetooth) to standardized local protocols (e.g., Matter). Users want to be able to control their smart-home devices regardless of the underlying communications protocols. Users also want to be able to control their devices both at home and remotely. Additionally, users want to control their devices from a variety of devices, such as a smartphone, an in-home smart display (e.g., by using voice commands or touch commands), a smart television (TV) (e.g., using a remote control), or a network-connected speaker (e.g., using voice commands). To improve the user experience with these devices and networks, there is a need to provide runtime software components that provide control of smart-home devices regardless of the underlying communications protocols, or the controlling device and its location.

### SUMMARY

This summary is provided to introduce simplified concepts of a smart-home management runtime a smart-home management runtime in home networks, generally related to managing communications in smart-home networks. The simplified concepts are further described below in the Detailed Description.

In aspects, methods, devices, systems, and means for a smart-home management runtime by a hub in a home network are described in which the hub discovers if other hubs are present on the home network. If one or more other hubs are discovered, the hub connects with the one or more other hubs, partitions smart-home hub functions between the hub and the one or more other hubs, and based on the partitioning, provides at least some of the smart-home functions to devices on the home network. If no other hubs are present on the home network, the hub provides the smart-home functions to devices on the home network.

The details of one or more implementations are set forth in the accompanying drawings and the following description. Other features and advantages will be apparent from the description and drawings and from the claims. This summary is provided to introduce subject matter that is further described in the Detailed Description and Drawings.

### BRIEF DESCRIPTION OF THE DRAWINGS

Aspects of a smart-home management runtime in home networks are described with reference to the following drawings. The same numbers are used throughout the drawings to reference like features and components:

FIG. 1 illustrates an example network environment in which various aspects of a smart-home management runtime in home networks can be implemented.

FIG. 2 illustrates an example home area network system in which various aspects of a smart-home management runtime in home networks can be implemented.

FIG. 3 illustrates an example system in accordance with aspects of a smart-home management runtime in home networks.

FIG. 4 illustrates an example method of a smart-home management runtime in home networks as in accordance with aspects of the techniques described herein.

FIG. 5 illustrates an example environment in which a home area network can be implemented in accordance with aspects of the techniques described herein.

FIG. 6 illustrates an example wireless network device that can be implemented in a home area network environment in accordance with one or more aspects of the techniques described herein.

FIG. 7 illustrates an example system with an example device that can implement aspects of a smart-home management runtime in home networks.

### DETAILED DESCRIPTION

This document describes techniques and devices to provide smart-home functions in line-powered and battery-powered hubs in a home network. In aspects, a smart-home management runtime (runtime) is described that is a set of software components that are integrated into mobile devices (e.g., smartphones, tablets), smart-home hub devices, smart TVs, set top boxes, network-connected speakers, Wireless Local Area Network (WLAN) routers, and the like. The runtime is configured to either be running on a powered smart-home hub device that is resident on a local network, a mobile device, or on a dual-mode device (e.g., a device that can be undocked and act as a mobile device or be docked and act as a hub device).

Hubs can negotiate what functions they provide, and sometimes may provide none. In an example where there are two hubs, one a smart television and the other a smart-home display device, the smart television device is much less power efficient and may have strict regulatory power requirements (e.g. in the European Union), such that it should only be used if it is the only available hub device, so the two hubs may negotiate to have all hub functionality be provided by the smart-home display device. There are a variety of reasons to choose a specific hub, such as regulatory requirements, power efficiency considerations, which hub has more available resources, which hub has better connectivity, and so forth.

### Example Environment

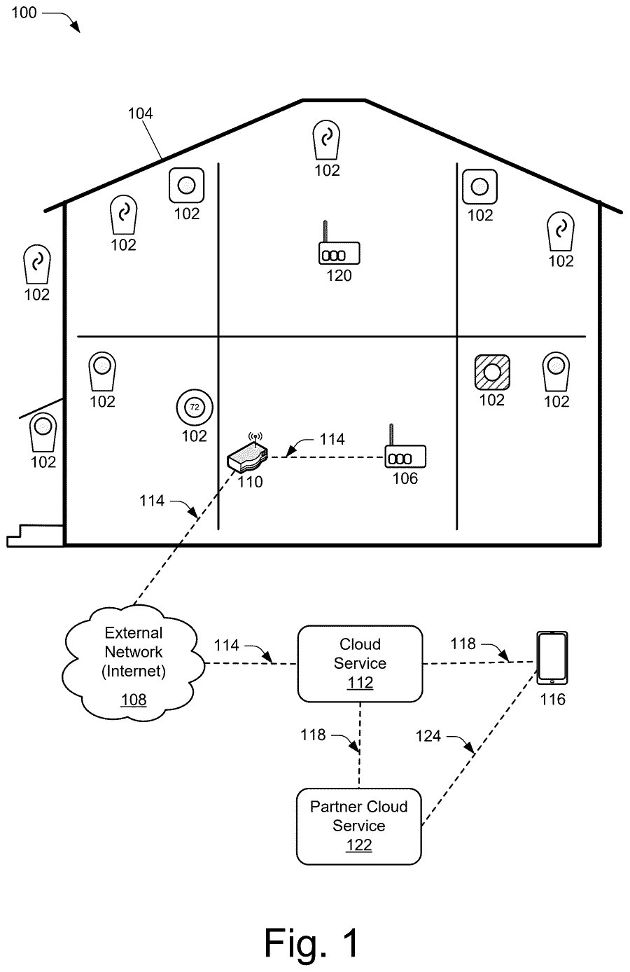

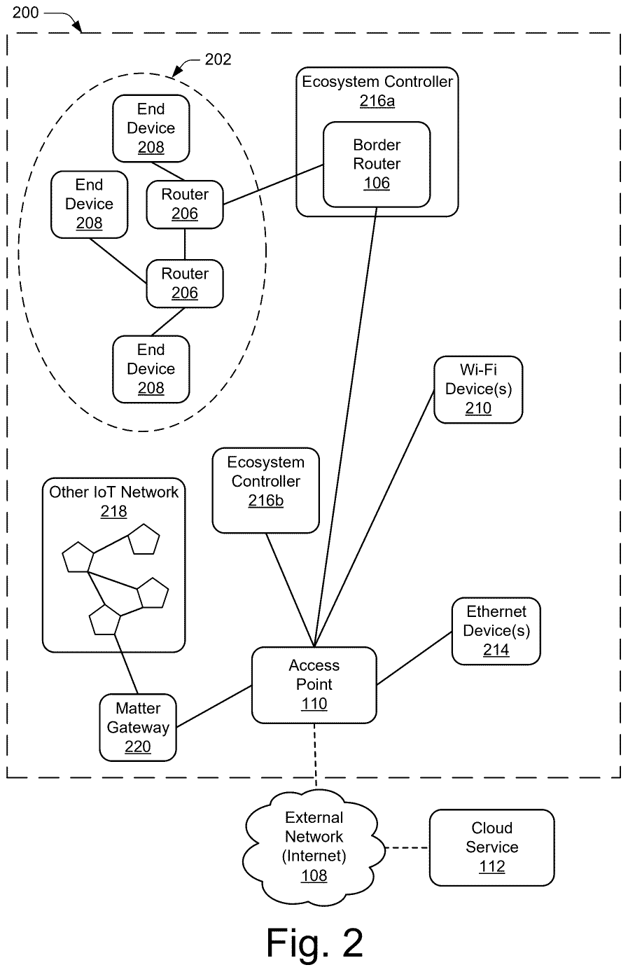

FIG. 1 illustrates an example network environment 100 in which aspects of a smart-home management runtime in home networks can be implemented. The network environment 100 includes a home area network (HAN) such as a HAN 200, described below with respect to FIG. 2. The HAN includes wireless network devices 102 that are disposed about a structure 104, such as a house, and are connected by one or more wireless and/or wired network technologies, as described below. The HAN includes a border router 106 that connects the HAN to an external network 108, such as the Internet, through a home router or access point 110.

To provide user access to functions implemented using the wireless network devices 102 in the HAN, a cloud service 112 connects to the HAN via border router 106, via a secure connection 114 through the external network 108 and the access point 110. The cloud service 112 facilitates communication between the HAN and internet clients 116, such as apps on mobile devices, using a web-based application programming interface (API) 118. The cloud service 112 also manages a home graph that describes connections and relationships between the wireless network devices 102, elements of the structure 104, and optionally users. The cloud service 112 hosts controllers which orchestrate and arbitrate home automation experiences, as described in greater detail below.

The HAN may include one or more wireless network devices 102 that function as a hub 120. The hub 120 may be a general-purpose home automation hub, a network-connected speaker, or an application-specific hub, such as a security hub, an energy management hub, an HVAC hub, and so forth. The functionality of a hub 120 may also be integrated into any wireless network device 102, such as a smart thermostat device or the border router 106. In addition to hosting controllers on the cloud service 112, controllers can be hosted on any hub 120 in the structure 104, such as the border router 106. A controller hosted on the cloud service 112 can be moved dynamically to the hub 120 in the structure 104, such as moving an HVAC zone controller to a newly installed smart thermostat.

Hosting functionality on the hub 120 in the structure 104 can improve reliability when the user's internet connection is unreliable, can reduce latency of operations that would normally have to connect to the cloud service 112, and can satisfy system and regulatory constraints around local access between wireless network devices 102. For example, the hub 120 in a Matter network can host the intelligence clusters and provide user access controls for access to the intelligence clusters.

The wireless network devices 102 in the HAN may be from a single manufacturer that provides the cloud service 112 as well, or the HAN may include wireless network devices 102 from partners. These partners may also provide partner cloud services 122 that provide services related to their wireless network devices 102 through a partner Web API 124. The partner cloud service 122 may optionally or additionally provide services to internet clients 116 via the web-based API 118, the cloud service 112, and the secure connection 114.

The network environment 100 can be implemented on a variety of hosts, such as battery-powered microcontroller-based devices, line-powered devices, and servers that host cloud services. Protocols operating in the wireless network devices 102 and the cloud service 112 provide a number of services that support operations of home automation experiences in the distributed computing environment 100. These services include, but are not limited to, real-time distributed data management and subscriptions, command-and-response control, real-time event notification, historical data logging and preservation, cryptographically controlled security groups, time synchronization, network and service pairing, and software updates.

FIG. 2 illustrates an example home area network system (e.g., Matter network, Weave network, fabric network) in which various aspects of sharing intelligence-derived information in home networks can be implemented. The home area network (HAN) 200 (Matter network 200) includes a wireless mesh network 202 (e.g., a Thread network) and Wi-Fi device(s) 210. The HAN 200 may also include wired network devices (e.g., Ethernet device(s) 214). The wireless mesh network 202 includes routers 206 and end devices 208. The routers 206 and the end devices 208, each include a mesh network interface for communication over the mesh network 202. The routers 206 receive and transmit packet data over the mesh network interface. The routers 206 also route traffic across the mesh network 202. The end devices 208 are devices that can communicate using the mesh network 202, but lack the capability, beyond simply forwarding to its parent router 206, to route traffic in the mesh network 202. For example, a battery-powered sensor is one type of end device 208. Each Wi-Fi device 210 includes a Wi-Fi network interface for communication over a Wi-Fi network. The Wi-Fi devices 210 and/or the Ethernet devices 214 can include home automation devices as well as devices that include applications to control Matter devices (e.g., a smartphone, a tablet, a network-connected speaker).

An ecosystem controller 216a (e.g., a Matter controller) can include the border router 106, which in turn, is included in the wireless mesh network 202. The border router 106 includes a mesh network interface for communication over the mesh network 202 and a Wi-Fi network interface for communication over the Wi-Fi network 204, or the border router 106 uses the Wi-Fi network interface of the ecosystem controller 216a for communication over the Wi-Fi network 204. The border router 106 routes packets between devices in the wireless mesh network 202 and the access point 110, which can forward packets to other devices in the HAN 200. The border router 106 also routes packets between devices in the mesh network 202 and external network nodes (e.g., the cloud service 112) via the external network 108, such as the Internet, through a home router or access point 110.

The HAN 200 includes one or more ecosystem controllers 216 that provide an interface between devices from an ecosystem vendor and the access point 110. For example, the ecosystem controller 216a provides an interface between the mesh network 202 (a Thread network) and the access point 110. Optionally, the HAN 200 may include other ecosystem controllers, such as ecosystem controller 216b, to interface to devices from other ecosystem vendors. Additionally, other, devices from another IoT network 218 (e.g., non-Matter compatible ecosystem devices) can be connected to the access point 110 by a Matter gateway 220 that provides connectivity for Matter-capable applications to devices in the other IoT network 218.

The devices in the mesh network 202, the Wi-Fi device(s) 210, the Ethernet device(s) 214, the ecosystem controllers 216, and Matter gateway 220 use standard IP routing configurations to communicate with each other through transport protocols such as the User Datagram Protocol (UDP) or the Transmission Control Protocol (TCP).

### Smart-Home Management Runtime

The smart-home management runtime (runtime) is a set of software components that are integrated into mobile devices (e.g., smartphones, tablets), smart-home hub devices, smart TVs, set top boxes, network-connected speakers, Wireless Local Area Network (WLAN) routers, and the like. The runtime is configured to either be running on a line-powered smart-home hub device that is resident on a local network, a mobile device, or on a dual-mode device (e.g., a device that can be undocked and act as a mobile device or be docked and act as a hub device).

In hub devices, or dual-mode devices currently docked and acting as a hub, the runtime automatically discovers and connects with all other hub runtimes in the home. The set of hub runtimes then automatically partition smart-home hub functions between one another. Examples of partitioned hub functions include: determining which hub device(s) are responsible for maintaining cloud connections to support cloud functionality, determining which hub device(s) are responsible for running smart-home automations locally, and/or determining which hub device(s) will be the one hub device to establish a connection to and maintain control of each Matter device on the local network. Hubs also cache Matter device state, allowing faster retrieval of that Matter device state as well as allowing sleepy, battery powered Matter devices to sleep rather than to have to service state read requests, thus extending their battery life significantly.

Non-hub (mobile, dual-mode) devices also participate in discovery, although they only discover hub devices, not non-hub devices. Non-hub discovery also determines whether the Runtime is present in the home (i.e. can directly connect to hubs and/or Matter devices) or outside the home (i.e. can only connect to a cloud service, which in turn connects to hubs in the home). When present in the home, non-hub discovery detects whether hubs are present, and if so, which functions each hub provides.

Once discovery is complete, the hub(s), that include the runtime, form a smart-home management network where all of the hubs cooperate to provide automatic discovery of all smart-home networked devices. Further after discovery is complete, the hub(s) manage Matter fabric connections management to ensure that every Matter device is reachable by first-party and third-party mobile applications. The runtimes in the mobile device(s) insulate first-party and third-party mobile applications from having to use different communications protocols and methods when controlling a Matter device from a device in the home versus a device outside the home. Additionally after discovery is complete, the runtimes in the mobile device(s) provide direct control of Matter devices by mobile devices if no hubs are available, provide first-party and third-party control of both Matter and cloud-integrated devices, and provide automatic enablement of first-party cloud functionality, such as cloud automations, for Matter devices in the home.

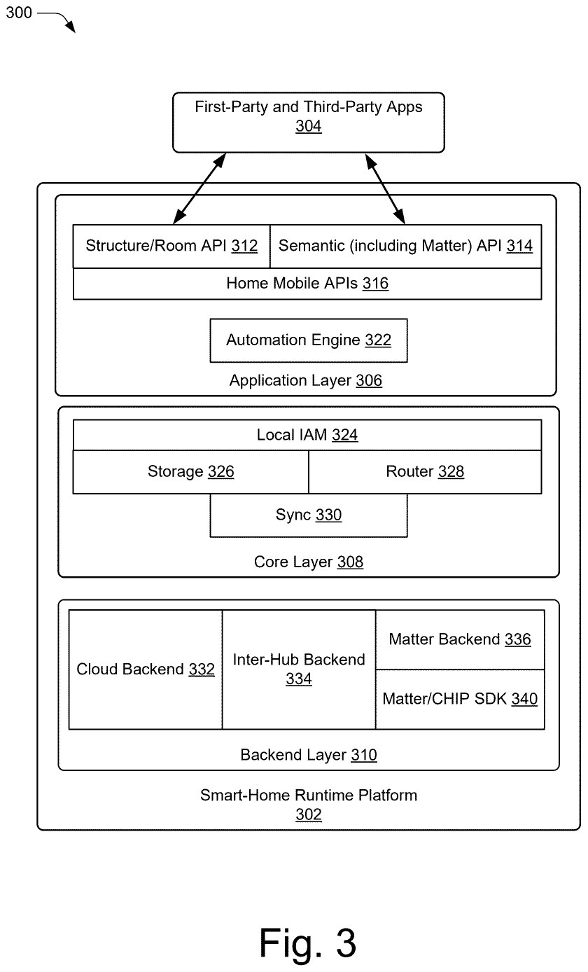

FIG. 3 illustrates an example runtime system in accordance with aspects of a smart-home management runtime. The system includes a smart-home runtime platform 302 that connects to first-party and third-party apps 304. The smart-home runtime platform 302, that is incorporated into the hub, includes an application layer 306, a core layer 308, and a backend layer 310.

The application layer 306 includes a structure/room application programming interface (API) 312, a semantic API 314, home mobile APIs 316, and a local Automation Engine 322. These APIs use a Matter-based trait model of devices and structures for expressing state and allowing control, leveraging developer functionality with the Matter standard to allow for easy understanding and use.

The core layer 308 includes core runtime functionality that is protocol and backend neutral. The core layer 308 acts as a bridge between the application layer 306 and the backend layer 310. The core layer provides caching, routing, and authentication/authorization (AuthN/AuthZ) functionality. The core layer 308 includes a local Identity and Access Management (IAM) component 324, a storage component 326, a router component 328, and a sync component 330. The storage component 326 providing storage similar to that described, above, with respect to the home graph.

The backend layer 310 includes functionality that abstracts away from the smart-home runtime platform-specific protocols and backends used to control smart devices. The backend layer 310 includes a cloud backend 332, an inter-hub backend 334, a Matter backend 336, and a Matter/CHIP software development kit (SDK) 340. The Matter backend 336 directly controls and monitors state of a Matter device. The inter-hub backend 334 coordinates with other smart-home hubs (e.g., when a particular hub is the “leader” for a Matter device, all other smart-home management devices go through it to communicate with that Matter device). The cloud backend 332 coordinates with the cloud services 112 when a hub is remote from the home and needs to go through the cloud to manipulate smart-home devices).

In aspects of the smart-home management runtime the application layer 306, the core layer 308, and the backend layer 310 form an integrated whole that are deployed together on battery and line-powered hubs. Additionally or alternatively, battery-powered hubs may not include the automation engine 322 and some line-powered hubs may not include the automation engine 322 if those line-powered hubs lack the resources to host the automation engine 322.

The home mobile APIs 316 are used by mobile apps to access smart-home runtime platform functionality. For example, the home mobile APIs 316 may be supported on mobile operating systems such as Android, iOS, or other operating systems.

The structure/room API 312 and semantic API 314 support a Matter trait-based model for various device types. For Android-based devices, different apps may be simultaneously accessing not only different structures but also be using different user accounts within the same logged-in Android User. The smart-home runtime platform 302 (in particular, the core layer 308) stores data, accepts commands, etc., for multiple structures with potentially different associated user accounts. The semantic API 314 can also be used to directly interact with Matter custom clusters.

All components within the core layer 308 use a standardized trait and command model. This model is based on Matter and is used to express the capabilities and functions of both Matter devices as well as devices connected via other means, e.g. cloud connected devices. This allows other components of the smart-home runtime platform 302 such as the local IAM layer 324 to reason about devices in a manner independent of their connectivity (e.g. local IAM 324 can reason about a light bulb being turned on, rather than Matter Cluster X CommandID Y and ensures that Matter interactions are lossless (e.g., the Tag-Length-Value (TLV) that an app passes into the Semantic API is the same TLV that gets sent over the wire)).

The automation engine 322 is an optional component that is only loaded on line-powered hubs. It integrates with cloud service 112 via the storage component 326. The cloud service 112 computes a set of automations that can execute purely locally (e.g. are time-based or depend only on local Matter device triggers and device actions), which are then synced by the sync component 330 to the storage 326 and loaded by the automation engine 322. The automation engine 322 then elects the best line-powered hub for each local automation, resulting in zero or more local automations per automation engine instance. The automation engine then listens for state changes (via a subscription to the storage 326) or events (via the router 328) for its automation triggers, then executes via commands or writes via the router 328. Executions are also logged directly to the cloud service 112 via the cloud backend 332.

The automation engine 322 belongs in the Application Layer 306 as it is a client of the core layer 308 and uses the same services as applications, subscribing to state and events and sending commands and writes.

The local IAM 324 component uses the storage component 326 to retrieve and subscribe to updates to PIP information, which includes the set of users (user accounts) and their roles within their structures, along with the policies associated with each role. Local IAM 324 is a PDP and will be an interceptor or lookaside on all calls from components in the application layer 306.

In one alternative, the supported Subjects that local IAM 324 acts as a PDP for user accounts that are used to determine the set of structures that are visible to the calling app along with what operations the app perform with which devices within those structures, to determine which local services (e.g., those of the automation engine 322) are trusted to manipulate devices in the same structure as a hub, and determine which applications can be used as a subject with the local IAM 324 and may have a more restricted set of permissions than another app. Optionally or additionally, the local IAM 324 includes controls such as supporting temporary roles (e.g. allow a security system installer to access certain devices during a specified installation window), as well as new roles that may require trait-level granularity (e.g. allow child accounts to lock but not unlock doors).

The smart-home runtime platform 302 never stores more information than the user accounts associated with the device are allowed to access. Thus, if two managers out of a structure with three managers have accounts on the device, the device will only store data relevant to those two managers and not the third, nor for any other user accounts or structures.

The storage component 326 acts as a read cache for structure information (rooms, devices, automations, and PIP information) and for state of and events from devices. This information is received from the sync component 330. All read and subscribe operations of this data are served out of the storage component 326. The storage component 326 maintains state for the active structure(s) of a smart-home runtime platform 302 device (hub), which are defined as the structure to which the device is assigned or the set of zero or more structures that are in use by apps (e.g. two mobile apps can each access different structures, and as long as the associated user account credentials the apps present can access those structures, then the storage component 326 will cache data for both apps). Write operations do not go through the storage component 326 and instead are handled by the router 328. Writes that cause state updates will be propagated into the storage component 326 via the sync component 330.

The sync component receives updates to all data mentioned in the Storage component from the cloud backend 322, the inter-hub backend 334, and the Matter backend 336. Updates to this data from the cloud are propagated to the storage component 326. This information is provided to the storage component 326 for the structure(s) associated with the smart-home runtime platform device.

For battery-powered smart-home runtime platform devices, the sync component 330 also treats device state as unidirectional, that is, state only goes from the cloud to the storage component 326. This is done because mobile devices are not considered sufficiently reliable sources of device state to mirror to the cloud.

For line-powered smart-home runtime platform devices, the sync component 330 treats device state as bidirectional to the cloud, in that the smart-home runtime platform device may be the local device leader for a Matter device, in which case the cloud relies on it to be authoritative for and synchronize all device state updates and events to the cloud as received from the Matter backend 336. Smart-home runtime platform to cloud synchronization will have rate limiting functionality to handle cases of excessively talkative Matter devices, compressing state updates into a single state update and buffering events as needed to keep queries-per-second (QPS) and bits-per-second (BPS) from being excessive.

The sync component 330 receives device state updates from other hubs, using the inter-hub backend 334, for the Matter devices for which those hubs are leader devices. This information is then propagated to the storage component 326. Information received by a hub from another hub via the inter-hub backend 334 is not propagated to the cloud because that other hub (the device leader) is expected to be synchronizing it to the cloud.

On all line-powered devices, the sync component 330 propagates device state updates and events it receives from the Matter backend 336 to the storage component 326, to the inter-hub backend 334 (for propagation to other hub devices), and to the cloud backend 332. Battery-powered hub devices do not propagate Matter state updates and events to the inter-hub backend 334 because they deactivate their Matter stack in favor of using a line-powered hub device if one is present or to the cloud backend 332 because state updates to the cloud when battery-powered often lead to incorrect state due to staleness when the battery-powered hub device leaves the home.

The router component 328 handles all commands and writes to devices and is responsible for dispatching them to the appropriate backend in the backend layer 310. The router 328 keeps track of the current connection state of the hub device, specifically, whether the hub device is on a local network (e.g., the hub can see devices on the Matter fabric and/or other hub devices) or remote. When the router 328 is on a remote hub, all commands and writes are routed to the cloud backend 332. When the router 328 is local, it is kept informed by the inter-hub backend 334 and the Matter backend 336 which devices are handled, via inter-hub communication for devices where other hubs are the Matter leader for the device or directly via the Matter backend 336 for Matter devices where the hub device is the leader. While initially the devices, which are being routed to, will only be Matter devices, the router 328 can also route commands to cloud integrated devices, which go through the cloud backend 332. Optionally or additionally, the router component 328 can route to other device types (e.g., for a backend that supports an additional communication protocol, such as a Bluetooth backend for non-Matter Bluetooth devices).

Both writes and commands received from the application layer 306 typically expect return values. When a command or write is sent to one of the router's backends it waits for a response that is then propagated to the caller.

The backend layer 310 contains the backends used to reach various destinations. All backends expose four basic functions:
Commands sent to a device—these typically also have return values (retvals) that must be propagated back to the caller (typically the router 328, which then propagates it back further).
Writes to a device—these are treated the same as commands and typically have retvals that include at least an indication of success or failure.
State updates—these are received and propagated up to the sync layer 330.
Events—these are treated the same as state updates and are propagated to the sync layer 330.

The backend layer 310 adopts a caching architecture where state updates are used to keep the storage layer 326 up to date, which then satisfies all reads and active subscriptions.

The cloud backend 332 handles the four basic functions in the following ways:
Commands—The only commands that target the cloud backend 322 come from apps via the Home Mobile APIs 316, and only when a battery-powered hub device is remote from the home. All of these commands will have a user account associated with them and will typically be user-initiated.
App Writes—Mobile apps can also perform device state writes. These will follow the same path as Commands when the hub device is remote, in that the cloud backend 332 on the hub will determine that a user authorization is present.
Non-App Writes—The automation engine 322 acts without user credentials and is treated as a trusted service within the hub. The automation engine 322 writes to the cloud when a local election changes in which the hub “owns” a particular automation. Line-powered hub devices may spread out the leadership of Matter devices such that no one line-powered hub device is the leader for every Matter device in the home. This is done via elections and will also result in a non-app write to the cloud from the line-powered hub device that wins the election of the leader for each Matter device. For non-app writes, the hub determines local trust is being used. These writes use device-based authentication and are propagated to cloud backends for authorization.
Events and State Updates—State updates and events can go from a device to the cloud (for line-powered hub devices receiving Matter device updates, and for automation executions) and cloud to device (for battery-powered hub devices, and for both battery and line-powered devices as cloud-integrated device support is added in the semantic API 314). In the aggregate this will be a large number of queries-per-second (QPS) (e.g., hundreds of thousands of QPS of device state updates are handled in the cloud) done with no person present. As such, these will use the Device-based authorization flow mentioned in the prior bullet.

The inter-hub backend 334 handles the four basic functions in the following ways:
Commands & Writes—Commands and writes to device traits are sent over the inter-hub backend 334 when a different, line-powered hub device is the leader for a Matter device. These commands are sent to the leader hub device, with the return value coming back. While battery-powered hub devices will only send (invoke) commands on other hub devices via the inter-hub backend 334, line-powered hub devices will both call other hub devices and receive commands and writes from other hub devices.
Events & State Updates—All battery and line-powered hub devices will receive events and state updates from other hub devices via subscription to the Matter state of another (line-powered) hub device that is the leader for the Matter device. This will require updates to non-hub devices as well to add this information to their subscribe-able state. State information thus received is propagated to the sync component 330 and then forwarded to the storage component 326 for caching.

On line-powered hub devices the inter-hub backend will send events and state updates received from the Matter backend 336 (via the sync component) to other hub devices as well.

The Matter backend handles the four basic functions (commands, writes, reads, and events) in different ways, depending on if the hub device is a remote battery-powered device, “home alone” battery-powered device, a battery-powered device in the presence of line-powered hub devices, or a line-powered device.

In both the case of a battery-powered device that is remote (unable to reach the Matter fabric) and in the case of a battery-powered device that is on the Matter fabric and detects other line-powered hub devices, the Matter backend 336 is not used. In the former case the cloud is used for access to Matter devices (assuming a line-powered device is present in the home) and in the latter case all commands and writes go over the inter-hub backend 334 to the line-powered hub device that is the leader for the Matter device in question.

In the case of a line-powered hub device, the Matter backend 336 holds an election with other line-powered hub devices and becomes the leader of one or more Matter devices. For those devices, it subscribes to all Matter state updates and events and forwards them to the sync component 330. If there are no other line-powered hub devices on the Matter fabric, the Matter backend 336 becomes the leader for all Matter devices on the network.

On battery-powered hub devices that are alone on the Matter fabric, with no line-powered hub devices present, the Matter backend behaves the same as a lone line-powered hub device, subscribing to and forwarding all state updates and events to the sync component 330. Optionally or additionally to optimize performance on battery-powered hub devices, the Matter backend 336 may be kept idle/offline until an app that uses the home mobile API launches and/or accesses those APIs, at which point it would subscribe to all state updates and events.

### Example Method

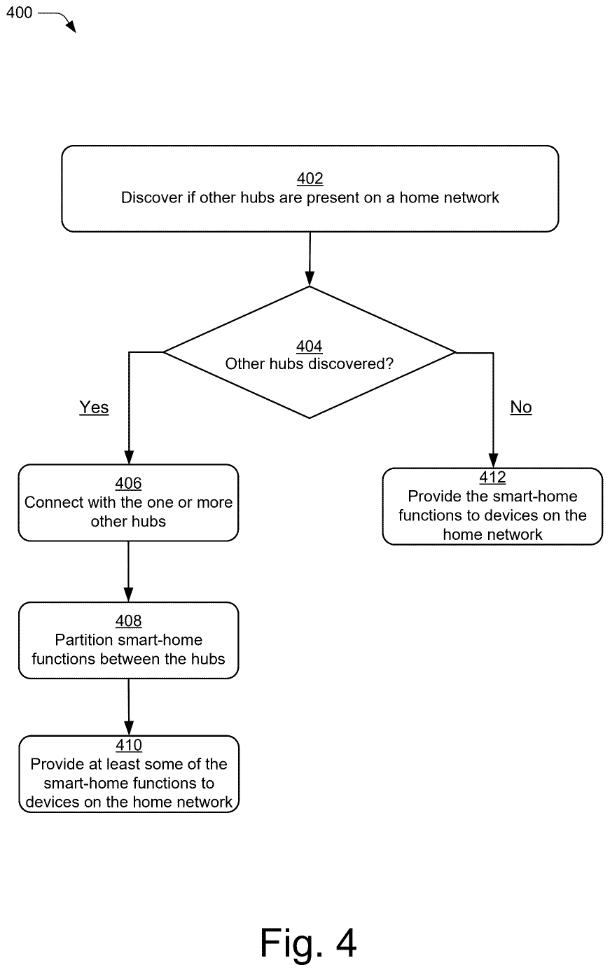

Example method 400 is described with reference to FIG. 4 in accordance with one or more aspects of a smart-home management runtime in home networks. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the method blocks are described is not intended to be construed as a limitation, and any number of the described method blocks can be combined in any order or skipped to implement a method or an alternate method.

FIG. 4 illustrates example method(s) 400 of a smart-home management runtime in home networks as generally related to managing communications in a smart-home network. At block 402, a hub discovers if other hubs are present on a home network. For example, a hub (e.g., the hub 546) uses the inter-hub backend 334 to initiate discovery of other hubs are present on the home network. For example, received state updates from other hubs can be analyzed to discover if other hubs are present on the network.

At block 404, the hub discovers that other hubs are on the home network and at 406 connects with one or more other hubs. For example, the hub device uses the inter-hub backend to communicate with the other hubs that are present on the home network.

At block 408, the hub device partitions smart-home functions between the hubs. For example, the hub device uses the inter-hub backend to communicate with the other hubs to partition the smart-home functions that are supported by each of the hub.

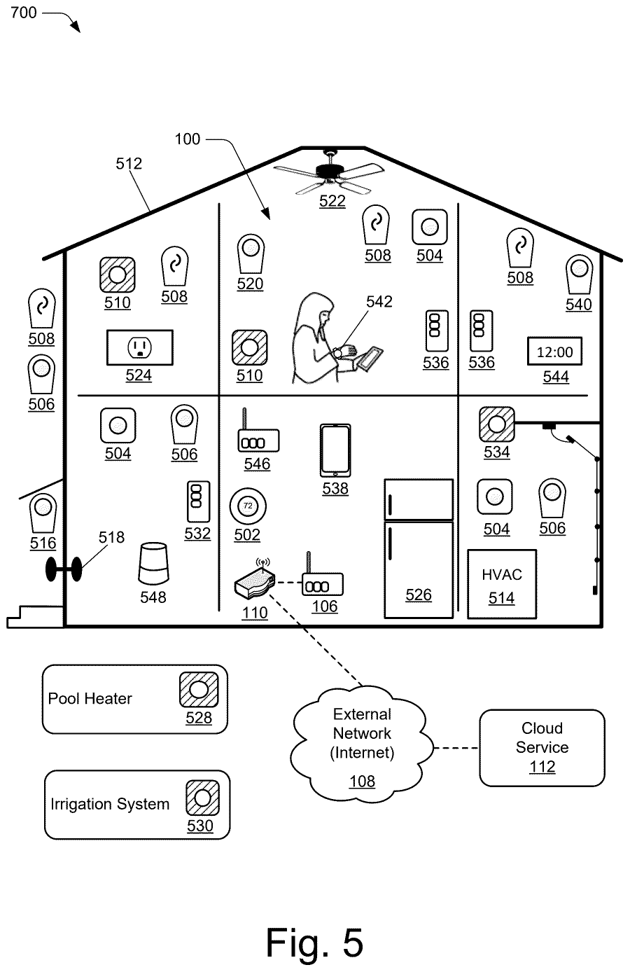

At block 410, the hub device provides at least some of the smart-home functions to devices on the home network. The term device can be used herein to refer to a wireless and/or wired network device that is configured for communication in a wireless network. Examples for devices on the home network are shown in FIG. 5. The wording “provides at least some of the smart-home functions to devices on the home network” can be substituted with the wording “provides at least one of the smart-home functions to a device on the home network.”

For example, the hub device provides a portion of the smart-home functions using the application layer 306, the core layer 308, and the backend layer 310.

At block 412, if no other hubs were discovered, the hub device provides the smart-home functions to devices on the home network. For example, the hub device provides the smart-home functions using the application layer 306, the core layer 308, and the backend layer 310.

### Example Environments and Devices

FIG. 5 illustrates an example environment 500 in which a home area network 200, as described with reference to FIG. 2, and aspects of a smart-home management runtime in home networks can be implemented. Generally, the environment 700 includes the home area network (HAN) 200 implemented as part of a home or other type of structure with any number of wireless and/or wired network devices that are configured for communication in a wireless network. For example, the wireless network devices can include a thermostat 502, hazard detectors 504 (e.g., for smoke and/or carbon monoxide), cameras 506 (e.g., indoor and outdoor), lighting units 508 (e.g., indoor and outdoor), and any other types of wireless network devices 510 that are implemented inside and/or outside of a structure 512 (e.g., in a home environment). In this example, the wireless network devices can also include any of the previously described devices, such as a border router 106, as well as any of the devices implemented as a router device 206, an end device 208, an ecosystem controller 216, and/or a Matter gateway 220.

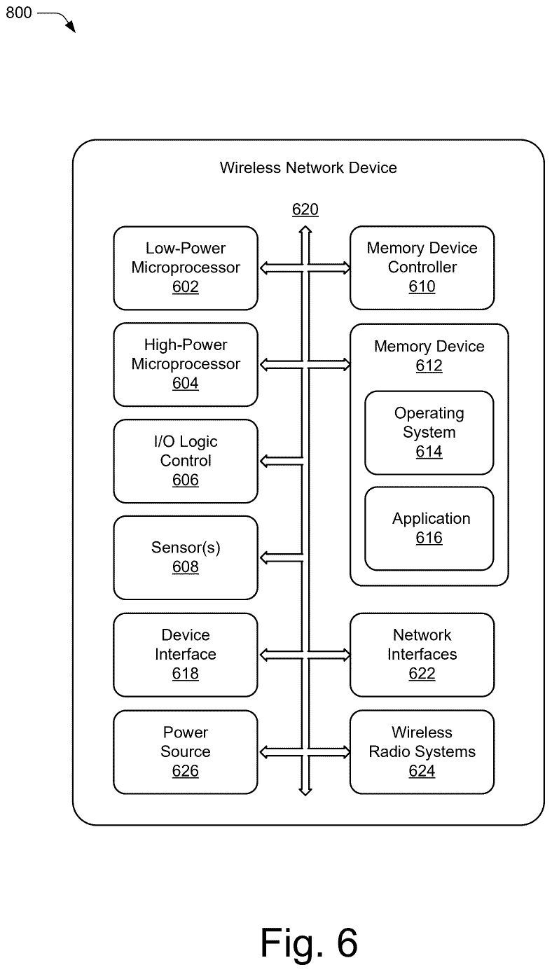

In the environment 500, any number of the wireless network devices can be implemented for wireless interconnection to wirelessly communicate and interact with each other. The wireless network devices are modular, intelligent, multi-sensing, network-connected devices that can integrate seamlessly with each other and/or with a central server or a cloud-computing system to provide any of a variety of useful automation objectives and implementations. An example of a wireless network device that can be implemented as any of the devices described herein is shown and described with reference to FIG. 6.

In implementations, the thermostat 502 may include a Nest® Learning Thermostat that detects ambient climate characteristics (e.g., temperature and/or humidity) and controls a HVAC system 514 in the home environment. The learning thermostat 502 and other network-connected devices “learn” by capturing occupant settings to the devices. For example, the thermostat learns preferred temperature set-points for mornings and evenings, and when the occupants of the structure are asleep or awake, as well as when the occupants are typically away or at home.

A hazard detector 504 can be implemented to detect the presence of a hazardous substance or a substance indicative of a hazardous substance (e.g., smoke, fire, or carbon monoxide). In examples of wireless interconnection, a hazard detector 704 may detect the presence of smoke, indicating a fire in the structure, in which case the hazard detector that first detects the smoke can broadcast a low-power wake-up signal to all of the connected wireless network devices. The other hazard detectors 504 can then receive the broadcast wake-up signal and initiate a high-power state for hazard detection and to receive wireless communications of alert messages. Further, the lighting units 508 can receive the broadcast wake-up signal and activate in the region of the detected hazard to illuminate and identify the problem area. In another example, the lighting units 508 may activate in one illumination color to indicate a problem area or region in the structure, such as for a detected fire or break-in, and activate in a different illumination color to indicate safe regions and/or escape routes out of the structure.

In various configurations, the wireless network devices 510 can include an entryway interface device 516 that functions in coordination with a network-connected door lock system 518, and that detects and responds to a person's approach to or departure from a location, such as an outer door of the structure 512. The entryway interface device 516 can interact with the other wireless network devices based on whether someone has approached or entered the smart-home environment. An entryway interface device 516 can control doorbell functionality, announce the approach or departure of a person via audio or visual means, and control settings on a security system, such as to activate or deactivate the security system when occupants come and go. The wireless network devices 510 can also include other sensors and detectors, such as to detect ambient lighting conditions, detect room-occupancy states (e.g., with an occupancy sensor 520), and control a power and/or dim state of one or more lights. In some instances, the sensors and/or detectors may also control a power state or speed of a fan, such as a ceiling fan 522. Further, the sensors and/or detectors may detect occupancy in a room or enclosure and control the supply of power to electrical outlets or devices 524, such as if a room or the structure is unoccupied.

The wireless network devices 510 may also include connected appliances and/or controlled systems 526, such as refrigerators, stoves and ovens, washers, dryers, air conditioners, pool heaters 528, irrigation systems 530, security systems 532, and so forth, as well as other electronic and computing devices, such as televisions, network-connected televisions, network-connected media streaming devices, entertainment systems, computers, intercom systems, garage-door openers 534, ceiling fans 522, control panels 536, and the like. When plugged in, an appliance, device, or system can announce itself to the home area network as described above and can be automatically integrated with the controls and devices of the home area network, such as in the home. It should be noted that the wireless network devices 510 may include devices physically located outside of the structure, but within wireless communication range, such as a device controlling a swimming pool heater 528 or an irrigation system 530.

As described above, the mesh network 202 includes a border router 106 that interfaces for communication with an external network, outside the mesh network 202. The border router 106 connects to an access point 110, which connects to the communication network 108, such as the Internet. A cloud service 112, which is connected via the communication network 108, provides services related to and/or using the devices within the HAN 200. By way of example, the cloud service 112 can include applications for connecting end user devices 538, such as smartphones, tablets, and the like, to devices in the home area network, processing and presenting data acquired in the HAN 200 to end users, linking devices in one or more HANs 200 to user accounts of the cloud service 112, provisioning and updating devices in the HAN 200, and so forth. For example, a user can control the thermostat 502 and other wireless network devices in the home environment using a network-connected computer or portable device, such as a mobile phone or tablet device. Further, the wireless network devices can communicate information to any central server or cloud-computing system via the border router 106, an ecosystem controller 216, a Matter gateway 220, and/or the access point 110. The data communications can be carried out using any of a variety of custom or standard wireless protocols (e.g., Wi-Fi, ZigBee for low power, 6LoWPAN, Thread, BLE, Matter, etc.) and/or by using any of a variety of custom or standard wired protocols (Ethernet, HomePlug, etc.).

Any of the wireless network devices in the HAN 200 can serve as low-power and communication nodes to create the HAN 200 in the home environment. Individual low-power nodes of the network can regularly send out messages regarding what they are sensing, and the other low-powered nodes in the environment-in addition to sending out their own messages—can repeat the messages, thereby communicating the messages from node to node (i.e., from device to device) throughout the home area network. The wireless network devices can be implemented to conserve power, particularly when battery-powered, utilizing low-powered communication protocols to receive the messages, translate the messages to other communication protocols, and send the translated messages to other nodes and/or to a central server or cloud-computing system. For example, an occupancy and/or ambient light sensor can detect an occupant in a room as well as measure the ambient light, and activate the light source when the ambient light sensor 540 detects that the room is dark and when the occupancy sensor 520 detects that someone is in the room. Further, the sensor can include a low-power wireless communication chip (e.g., an IEEE 802.15.4 chip, a Thread chip, a ZigBee chip) that regularly sends out messages regarding the occupancy of the room and the amount of light in the room, including instantaneous messages coincident with the occupancy sensor detecting the presence of a person in the room. As mentioned above, these messages may be sent wirelessly, using the home area network, from node to node (i.e., network-connected device to network-connected device) within the home environment as well as over the Internet to a central server or cloud-computing system.

In other configurations, various ones of the wireless network devices can function as “tripwires” for an alarm system in the home environment. For example, in the event a perpetrator circumvents detection by alarm sensors located at windows, doors, and other entry points of the structure or environment, the alarm could still be triggered by receiving an occupancy, motion, heat, sound, etc. message from one or more of the low-powered mesh nodes in the home area network. In other implementations, the home area network can be used to automatically turn on and off the lighting units 508 as a person transitions from room to room in the structure. For example, the wireless network devices can detect the person's movement through the structure and communicate corresponding messages via the nodes of the home area network. Using the messages that indicate which rooms are occupied, other wireless network devices that receive the messages can activate and/or deactivate accordingly. As referred to above, the home area network can also be utilized to provide exit lighting in the event of an emergency, such as by turning on the appropriate lighting units 508 that lead to a safe exit. The light units 508 may also be turned-on to indicate the direction along an exit route that a person should travel to safely exit the structure.

The various wireless network devices may also be implemented to integrate and communicate with wearable computing devices 542, such as may be used to identify and locate an occupant of the structure, and adjust the temperature, lighting, sound system, and the like accordingly. In other implementations, RFID sensing (e.g., a person having an RFID bracelet, necklace, or key fob), synthetic vision techniques (e.g., video cameras and face recognition processors), audio techniques (e.g., voice, sound pattern, vibration pattern recognition), ultrasound sensing/imaging techniques, and infrared or near-field communication (NFC) techniques (e.g., a person wearing an infrared or NFC-capable smartphone), along with rules-based inference engines or artificial intelligence techniques that draw useful conclusions from the sensed information as to the location of an occupant in the structure or environment.

In other implementations, personal comfort-area networks, personal health-area networks, personal safety-area networks, and/or other such human-facing functionalities of service robots can be enhanced by logical integration with other wireless network devices and sensors in the environment according to rules-based inferencing techniques or artificial intelligence techniques for achieving better performance of these functionalities. In an example relating to a personal health-area, the system can detect whether a household pet is moving toward the current location of an occupant (e.g., using any of the wireless network devices and sensors), along with rules-based inferencing and artificial intelligence techniques. Similarly, a hazard detector service robot can be notified that the temperature and humidity levels are rising in a kitchen, and temporarily raise a hazard detection threshold, such as a smoke detection threshold, under an inference that any small increases in ambient smoke levels will most likely be due to cooking activity and not due to a genuinely hazardous condition. Any service robot that is configured for any type of monitoring, detecting, and/or servicing can be implemented as a mesh node device on the home area network, conforming to the wireless interconnection protocols for communicating on the home area network.

The wireless network devices 510 may also include a network-connected alarm clock 544 for each of the individual occupants of the structure in the home environment. For example, an occupant can customize and set an alarm device for a wake time, such as for the next day or week. Artificial intelligence can be used to consider occupant responses to the alarms when they go off and make inferences about preferred sleep patterns over time. An individual occupant can then be tracked in the home area network based on a unique signature of the person, which is determined based on data obtained from sensors located in the wireless network devices, such as sensors that include ultrasonic sensors, passive IR sensors, and the like. The unique signature of an occupant can be based on a combination of patterns of movement, voice, height, size, etc., as well as using facial recognition techniques.

In an example of wireless interconnection, the wake time for an individual can be associated with the thermostat 502 to control the HVAC system in an efficient manner so as to pre-heat or cool the structure to desired sleeping and awake temperature settings. The preferred settings can be learned over time, such as by capturing the temperatures set in the thermostat before the person goes to sleep and upon waking up. Collected data may also include biometric indications of a person, such as breathing patterns, heart rate, movement, etc., from which inferences are made based on this data in combination with data that indicates when the person actually wakes up. Other wireless network devices can use the data to provide other automation objectives, such as adjusting the thermostat 502 so as to pre-heat or cool the environment to a desired setting and turning-on or turning-off the lights 508.

In implementations, the wireless network devices can also be utilized for sound, vibration, and/or motion sensing such as to detect running water and determine inferences about water usage in a home environment based on algorithms and mapping of the water usage and consumption. This can be used to determine a signature or fingerprint of each water source in the home and is also referred to as “audio fingerprinting water usage.” Similarly, the wireless network devices can be utilized to detect the subtle sound, vibration, and/or motion of unwanted pests, such as mice and other rodents, as well as by termites, cockroaches, and other insects. The system can then notify an occupant of the suspected pests in the environment, such as with warning messages to help facilitate early detection and prevention.

The environment 500 may include one or more wireless network devices that function as a hub 546. The hub 546 may be a general-purpose home automation hub, or an application-specific hub, such as a security hub, an energy management hub, an HVAC hub, and so forth. The functionality of a hub 546 may also be integrated into any wireless network device, such as a network-connected thermostat device or the border router 106. Hosting functionality on the hub 546 in the structure 512 can improve reliability when the user's internet connection is unreliable, can reduce latency of operations that would normally have to connect to the cloud service 112, and can satisfy system and regulatory constraints around local access between wireless network devices.

Additionally, the example environment 500 includes a network-connected-speaker 548. The network-connected speaker 548 provides voice assistant services that include providing voice control of network-connected devices. The functions of the hub 546 may be hosted in the network-connected speaker 548. The network-connected speaker 548 can be configured to communicate via the wireless mesh network 202, the Wi-Fi network 204, or both.

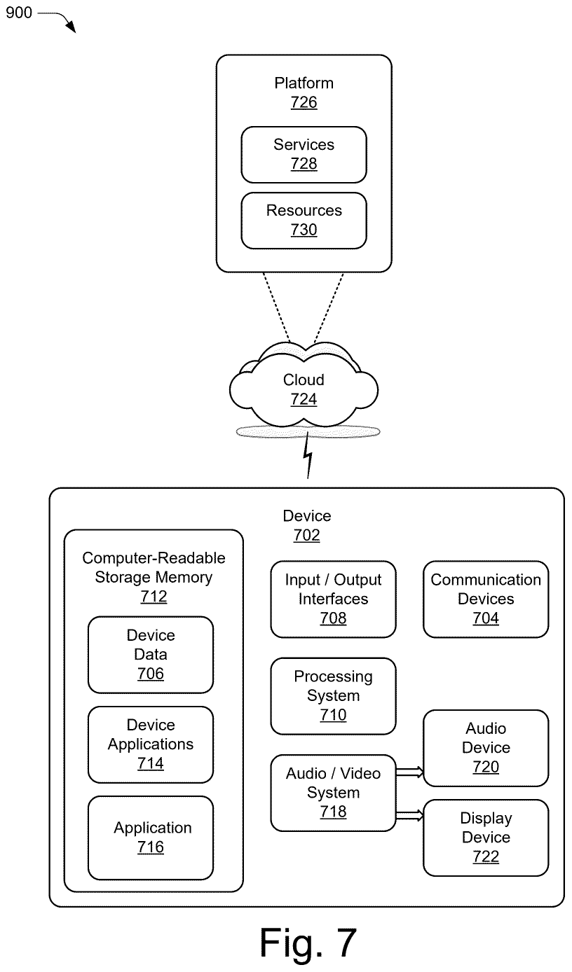

FIG. 6 illustrates an example wireless network device 600 that can be implemented as any of the wireless network devices in a home area network (Thread network, Matter network) in accordance with one or more aspects of a smart-home management runtime in home networks as described herein. The device 600 can be integrated with electronic circuitry, microprocessors, memory, input output (I/O) logic control, communication interfaces and components, as well as other hardware, firmware, and/or software to implement the device in a home area network. Further, the wireless network device 600 can be implemented with various components, such as with any number and combination of different components as further described with reference to the example device shown in FIG. 7.

In this example, the wireless network device 600 includes a low-power microprocessor 602 and a high-power microprocessor 604 (e.g., microcontrollers or digital signal processors) that process executable instructions. The device also includes an input-output (I/O) logic control 606 (e.g., to include electronic circuitry). The microprocessors can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The low-power microprocessor 602 and the high-power microprocessor 604 can also support one or more different device functionalities of the device. For example, the high-power microprocessor 604 may execute computationally intensive operations, whereas the low-power microprocessor 602 may manage less-complex processes such as detecting a hazard or temperature from one or more sensors 608. The low-power processor 602 may also wake or initialize the high-power processor 604 for computationally intensive processes.

The one or more sensors 608 can be implemented to detect various properties such as acceleration, temperature, humidity, water, supplied power, proximity, external motion, device motion, sound signals, ultrasound signals, light signals, fire, smoke, carbon monoxide, global-positioning-satellite (GPS) signals, radio frequency (RF), other electromagnetic signals or fields, or the like. As such, the sensors 608 may include any one or a combination of temperature sensors, humidity sensors, hazard-related sensors, security sensors, other environmental sensors, accelerometers, microphones, optical sensors up to and including cameras (e.g., charged coupled-device or video cameras, active or passive radiation sensors, GPS receivers, and radio frequency identification detectors. In implementations, the wireless network device 600 may include one or more primary sensors, as well as one or more secondary sensors, such as primary sensors that sense data central to the core operation of the device (e.g., sensing a temperature in a thermostat or sensing smoke in a smoke detector), while the secondary sensors may sense other types of data (e.g., motion, light or sound), which can be used for energy-efficiency objectives or automation objectives.

The wireless network device 600 includes a memory device controller 610 and a memory device 612, such as any type of a nonvolatile memory and/or other suitable electronic data storage device. The wireless network device 600 can also include various firmware and/or software, such as an operating system 614 that is maintained as computer executable instructions by the memory and executed by a microprocessor. The device software may also include an application 616 that implements aspects of a smart-home management runtime in home networks. The wireless network device 600 also includes a device interface 618 to interface with another device or peripheral component and includes an integrated data bus 620 that couples the various components of the wireless network device for data communication between the components. The data bus in the wireless network device may also be implemented as any one or a combination of different bus structures and/or bus architectures.

The device interface 618 may receive input from a user and/or provide information to the user (e.g., as a user interface), and a received input can be used to determine a setting. The device interface 618 may also include mechanical or virtual components that respond to a user input. For example, the user can mechanically move a sliding or rotatable component, or the motion along a touchpad may be detected, and such motions may correspond to a setting adjustment of the device. Physical and virtual movable user-interface components can allow the user to set a setting along a portion of an apparent continuum. The device interface 618 may also receive inputs from any number of peripherals, such as buttons, a keypad, a switch, a microphone, and an imager (e.g., a camera device).

The wireless network device 600 can include network interfaces 622, such as a home area network interface for communication with other wireless network devices in a home area network, and an external network interface for network communication, such as via the Internet. The wireless network device 600 also includes wireless radio systems 624 for wireless communication with other wireless network devices via the home area network interface and for multiple, different wireless communications systems. The wireless radio systems 624 may include Wi-Fi, Bluetooth™, Mobile Broadband, BLE, and/or point-to-point IEEE 802.15.4. Each of the different radio systems can include a radio device, antenna, and chipset that is implemented for a particular wireless communications technology. The wireless network device 600 also includes a power source 626, such as a battery and/or to connect the device to line voltage. An AC power source may also be used to charge the battery of the device.

FIG. 7 illustrates an example system 700 that includes an example device 702, which can be implemented as any of the wireless network devices that implement aspects of a smart-home management runtime in home networks as described with reference to the previous FIGS. 1-6. The example device 702 may be any type of computing device, client device, mobile phone, tablet, communication, entertainment, gaming, media playback, and/or other type of device. Further, the example device 702 may be implemented as any other type of wireless network device that is configured for communication on a home area network, such as a thermostat, hazard detector, camera, light unit, commissioning device, router, border router, joiner router, joining device, end device, leader, access point, and/or other wireless network devices.

The device 702 includes communication devices 704 that enable wired and/or wireless communication of device data 706, such as data that is communicated between the devices in a home area network, data that is being received, data scheduled for broadcast, data packets of the data, data that is synched between the devices, etc. The device data can include any type of communication data, as well as audio, video, and/or image data that is generated by applications executing on the device. The communication devices 704 can also include transceivers for cellular phone communication and/or for network data communication.

The device 702 also includes input/output (I/O) interfaces 708, such as data network interfaces that provide connection and/or communication links between the device, data networks (e.g., a home area network, external network, etc.), and other devices. The I/O interfaces can be used to couple the device to any type of components, peripherals, and/or accessory devices. The I/O interfaces also include data input ports via which any type of data, media content, and/or inputs can be received, such as user inputs to the device, as well as any type of communication data, as well as audio, video, and/or image data received from any content and/or data source.

The device 702 includes a processing system 710 that may be implemented at least partially in hardware, such as with any type of microprocessors, controllers, and the like that process executable instructions. The processing system can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The device 702 may further include any type of a system bus or other data and command transfer system that couples the various components within the device. A system bus can include any one or combination of different bus structures and architectures, as well as control and data lines.

The device 702 also includes computer-readable storage memory 712 (computer-readable storage media 712), such as data storage devices that can be accessed by a computing device, and that provide persistent storage of data and executable instructions (e.g., software applications, modules, programs, functions, and the like). The computer-readable storage memory described herein excludes propagating signals. Examples of computer-readable storage memory include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage memory in various memory device configurations.

The computer-readable storage memory 712 provides storage of the device data 706 and various device applications 714, such as an operating system that is maintained as a software application with the computer-readable storage memory and executed by the processing system 710. The device applications may also include a device manager, such as any form of a control application, software application, signal processing and control module, code that is native to a particular device, a hardware abstraction layer for a particular device, and so on. In this example, the device applications also include an application 716 that implements aspects of a smart-home management runtime in home networks, such as when the example device 702 is implemented as any of the wireless network devices described herein.

The device 702 also includes an audio and/or video system 718 that generates audio data for an audio device 720 and/or generates display data for a display device 722. The audio device and/or the display device include any devices that process, display, and/or otherwise render audio, video, display, and/or image data, such as the image content of a digital photo. In implementations, the audio device and/or the display device are integrated components of the example device 702. Alternatively, the audio device and/or the display device are external, peripheral components to the example device. In aspects, at least part of the techniques described for common interface for a smart-home management runtime in home networks may be implemented in a distributed system, such as over a “cloud” 724 in a platform 726. The cloud 724 includes and/or is representative of the platform 726 for services 728 and/or resources 730.

The platform 726 abstracts underlying functionality of hardware, such as server devices (e.g., included in the services 728) and/or software resources (e.g., included as the resources 730), and connects the example device 702 with other devices, servers, etc. The resources 730 may also include applications and/or data that can be utilized while computer processing is executed on servers that are remote from the example device 702. Additionally, the services 728 and/or the resources 730 may facilitate subscriber network services, such as over the Internet, a cellular network, or Wi-Fi network. The platform 726 may also serve to abstract and scale resources to service a demand for the resources 730 that are implemented via the platform, such as in an interconnected device aspect with functionality distributed throughout the system 900. For example, the functionality may be implemented in part at the example device 702 as well as via the platform 726 that abstracts the functionality of the cloud 724. In the following some examples are described:

Example 1: A method of a smart-home management runtime by a hub in a home network, the method comprising the hub:
discovering if other hubs are present on the home network;
if one or more other hubs are discovered:
   connecting with the one or more other hubs; and
   partitioning smart-home hub functions between the hub and the one or more other hubs; and
based on the partitioning, providing at least some of the smart-home functions to devices on the home network.

Example 2: The method of example 1, further comprising the hub:
if no other hubs are present on the home network, providing the smart-home functions to devices on the home network.

Example 3: The method of example 1, wherein the smart-home functions are provided by an application layer, a core layer, and a backend layer.

Example 4: The method of example 3, wherein the application layer includes one or more of:
a structure/room Application Programming Interface (API);
a semantic API;
one or more home or mobile APIs; or
an automation engine.

Example 5: The method of any one of the preceding examples, wherein the partitioning of the smart-home hub functions between the hub and the one or more other hubs comprises:
electing a particular hub to own a particular smart-home function.

Example 6: The method of example 5, further comprising:
receiving, by the automation engine, a set of one or more automations from a cloud service.

Example 7: The method of example 6, further comprising:
electing a hub of one or more hubs to preform each of the received automations.

Example 8: The method of example 7, wherein the one or more hubs are line-powered hubs.

Example 9: The method of example 5, wherein the election is based on one or more of:
a regulatory requirement;
power efficiency;
which hub has more available resources; or
which hub has better connectivity.

Example 10: The method of example 3, wherein the core layer includes one or more of:
a storage component;
a router;
a sync component; or
a local Identity and Access Management (IAM) layer.

Example 11: The method of example 3, wherein the backend layer includes one or more of:
a cloud backend component;
an inter-hub backend component; or
a Matter backend component.

Example 12: The method of any one of the preceding examples, wherein the home network is a Matter network.

Example 13: An electronic device comprising:
a network interface;
a processor; and
computer-readable storage media comprising instructions that, responsive to execution by the processor, direct the electronic device to perform any one of the methods in the preceding examples.

Example 14: The electronic device of example 13, wherein the electronic device is one of:
a mobile device;
a smartphone;
a tablet computer;
a television;
a Wireless Local Area Network (WLAN) router;
a network-connected speaker; or
a border router.

Example 15: A non-transitory computer-readable storage medium comprising instructions for a hub node, the instructions executable by one or more processors, to perform the method of any one of examples 1-12.

Although aspects of a smart-home management runtime in home networks have been described in language specific to features and/or methods, the subject of the appended claims is not necessarily limited to the specific features or methods described. Rather, the specific features and methods are disclosed as example implementations of a smart-home management runtime in home networks, and other equivalent features and methods are intended to be within the scope of the appended claims. Further, various different aspects are described, and it is to be appreciated that each described aspect can be implemented independently or in connection with one or more other described aspects.

1. A method of a smart-home management runtime by a hub in a home network, the method comprising the hub:
discovering if other hubs are present on the home network;
if one or more other hubs are discovered:
connecting with the one or more other hubs; and
partitioning smart-home hub functions between the hub and the one or more other hubs; and
based on the partitioning, providing at least some of the smart-home functions to devices on the home network.

2. The method of claim 1, further comprising the hub:
if no other hubs are present on the home network, providing the smart-home functions to devices on the home network.

3. The method of claim 1, wherein the smart-home functions are provided by an application layer, a core layer, and a backend layer.

4. The method of claim 3, wherein the application layer includes one or more of:
a structure/room Application Programming Interface (API);
a semantic API;
one or more home or mobile APIs; or
an automation engine.

5. The method of claim 1, wherein the partitioning of the smart-home hub functions between the hub and the one or more other hubs comprises:
electing a particular hub to own a particular smart-home function.

6. The method of claim 5, further comprising:
receiving, by an automation engine, a set of one or more automations from a cloud service.

7. The method of claim 6, further comprising:
electing a hub of one or more hubs to perform each of the received automations.

8. The method of claim 7, wherein the one or more hubs are line-powered hubs.

9. The method of claim 5, wherein the election is based on one or more of:
a regulatory requirement;
power efficiency;
which hub has more available resources; or
which hub has better connectivity.

10. The method of claim 3, wherein the core layer includes one or more of:
a storage component;
a router;
a sync component; or
a local Identity and Access Management (IAM) layer.

11. The method of claim 3, wherein the backend layer includes one or more of:
a cloud backend component;
an inter-hub backend component; or
a Matter backend component.

12. The method of claim 1, wherein the home network is a Matter network.

13. An electronic device comprising:
a network interface;
a processor; and
computer-readable storage media comprising instructions that, responsive to execution by the processor, direct the electronic device to:
discover if other hubs are present on a home network;
if one or more other hubs are discovered:
connect with the one or more other hubs; and
partition smart-home hub functions between the hub and the one or more other hubs; and
based on the partitioning, provide at least some of the smart-home functions to devices on the home network.

14. The electronic device of claim 13, wherein the electronic device is one of:
a mobile device;
a smartphone;
a tablet computer;
a television;
a Wireless Local Area Network (WLAN) router;
a network-connected speaker; or
a border router.

15. A non-transitory computer-readable storage medium comprising instructions for a hub node, the instructions executable by one or more processors, to:
discover if other hubs are present on a home network;
if one or more other hubs are discovered:
connect with the one or more other hubs; and
partition smart-home hub functions between the hub and the one or more other hubs; and
based on the partitioning, provide at least some of the smart-home functions to devices on the home network.

16. The non-transitory computer-readable storage medium of claim 15, the instructions further executable to:
if no other hubs are present on the home network, provide the smart-home functions to devices on the home network.

17. The electronic device of claim 13, the instructions further executable to by the processor, to direct the electronic device to:
if no other hubs are present on the home network, provide the smart-home functions to devices on the home network.

18. The electronic device of claim 13, wherein the smart-home functions are provided by an application layer, a core layer, and a backend layer.

19. The electronic device of claim 18, wherein the application layer includes one or more of:
a structure/room Application Programming Interface (API);
a semantic API;
one or more home or mobile APIs; or
an automation engine.

20. The electronic device of claim 13. wherein the partitioning of the smart-home hub functions between the hub and the one or more other hubs comprises:
electing a particular hub to own a particular smart-home function.
